(19) United States
(12) Patent Application Publication
(10) Pub. No.: US 2026/0140252 A1
(43) Pub. Date: May 21, 2026

(54) COMMUNICATION DEVICE THAT PERFORMS SENSING BASED ON MONO-STATIC ARCHITECTURE

(71) Applicant: Realtek Semiconductor Corp., HsinChu (TW)

(72) Inventors: Shau-Yu Cheng, HsinChu (TW); Jhe-Yi Lin, HsinChu (TW); Yi-Ru Lai, HsinChu (TW); Der-Zheng Liu, HsinChu (TW)

(73) Assignee: Realtek Semiconductor Corp., HsinChu (TW)

(21) Appl. No.: 19/372,261

(22) Filed: Oct. 29, 2025

Related U.S. Application Data
(60) Provisional application No. 63/721,548, filed on Nov. 17, 2024.
(60) Provisional application No. 63/726,244, filed on Nov. 28, 2024.

(30) Foreign Application Priority Data
Sep. 30, 2025 (TW) 114137554

(51) Int. Cl. G01S 13/76

(52) U.S. Cl. CPC G01S 13/765

(57) ABSTRACT

A communication device includes a first transmitting signal processing circuit, a first receiving signal processing circuit, a baseband signal processing circuit, and a control unit. The first transmitting signal processing circuit is enabled in a sensing mode, and transmits a first radio frequency (RF) signal within a wireless communication environment, wherein the first RF signal comprises a predetermined packet. The first receiving signal processing circuit is enabled in the sensing mode, and receives a second RF signal, wherein the second RF signal includes a first packet originating from the predetermined packet. The baseband signal processing circuit generates the predetermined packet according to bit stream data, receives the first packet from the first receiving signal processing circuit, and performs a channel estimation operation according to the first packet in order to generate channel information. The control unit determines an object characteristic within the wireless communication environment according to the channel information.

### CROSS REFERENCE TO RELATED APPLICATIONS

This application claims the benefit of U.S. Provisional Application No. 63/721,548, filed on Nov. 17th, 2024. Further, this application claims the benefit of U.S. Provisional Application No. 63/726,244, filed on Nov. 28th, 2024. The contents of these applications are incorporated herein by reference.

### BACKGROUND OF THE INVENTION

### 1. Field of the Invention

The present invention is related to a communication device that performs sensing by utilizing Wi-Fi communication technology, and more particularly, to a Wi-Fi communication device that performs sensing based on a mono-static architecture.

### 2. Description of the Prior Art

Wi-Fi has become a mainstream technology used in modern wireless communications due to its excellent performance with regards to transmission speed, coverage, and available number of connected devices. With the widespread adoption of Wi-Fi devices, additional applications based on Wi-Fi communication have begun to flourish. For example, technologies that use Wi-Fi signals for positioning or sensing are rapidly being developed.

Due to limitations in the Wi-Fi infrastructure, however, current Wi-Fi sensing technologies suffer from several issues that may significantly affect sensing accuracy. For example, overly large sensing ranges may lead to false alarms and difficulties in time synchronization make it hard to accurately measure the Time of Flight (ToF) of Non-Line-of-Sight (NLoS) paths. Both these issues cause ambiguity when interpreting the movement of target objects.

As a result, optimizing Wi-Fi sensing technologies to improve accuracy and application value has become an important issue in the Wi-Fi communication field.

### SUMMARY OF THE INVENTION

It is therefore one of the objectives of the present invention to provide a Wi-Fi communication device that performs sensing based on a mono-static architecture, in order to address the above-mentioned issues.

According to an embodiment of the present invention, a communication device is provided. The communication device comprises a first transmitting signal processing circuit, a first receiving signal processing circuit, a baseband signal processing circuit, and a control unit. The first transmitting signal processing circuit is enabled in a sensing mode, and transmits a first radio frequency (RF) signal within a wireless communication environment, wherein the first RF signal comprises a predetermined packet. The first receiving signal processing circuit is enabled in the sensing mode, and receives a second RF signal, wherein the second RF signal comprises a first packet originating from the predetermined packet. The baseband signal processing circuit generates the predetermined packet according to bit stream data, receives the first packet from the first receiving signal processing circuit, and performs a channel estimation operation according to the first packet in order to generate channel information. The control unit determines an object characteristic within the wireless communication environment according to the channel information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an example of a communication device according to a first embodiment of the present invention.

FIG. 2 is a block diagram illustrating an example of a communication device according to a second embodiment of the present invention.

FIG. 3 is a block diagram illustrating an example of a communication device according to a third embodiment of the present invention.

FIG. 4 is a block diagram illustrating an example of a communication device according to a fourth embodiment of the present invention.

FIG. 5 is a block diagram illustrating an example of a communication device according to a fifth embodiment of the present invention.

FIG. 6 is a block diagram illustrating an example of a communication device according to a sixth embodiment of the present invention.

FIG. 7 is a block diagram illustrating an example of a communication device according to a seventh embodiment of the present invention.

FIG. 8 is a block diagram illustrating an example of a communication device according to an eighth embodiment of the present invention.

FIG. 9 is a block diagram illustrating an example of a communication device according to a ninth embodiment of the present invention.

FIG. 10 is a block diagram illustrating an example of a communication device according to a tenth embodiment of the present invention.

### DETAILED DESCRIPTION

The present invention belongs to the Integrated Sensing and Communication (ISAC) field which performs sensing using Wi-Fi communication technology in a mono-static (or single-base) configuration. For simplicity, the term “sensing” is used in the following descriptions to represent the above concept. In addition, the term “mono-static” or “single-base” refers to configurations where both the transmitter and the receiver for sensing signals or packets are located within the same device. Relatively, in a bi-static (or multi-static) mode, the transmitter and the receiver are placed in separate devices, such as two or more independent communication devices.

In embodiments of the present invention, by integrating the mono-static sensing function into the existing Wi-Fi communication framework, the sensing limitations of Wi-Fi communication infrastructure are effectively addressed, and more particularly, the applicability and accuracy of Wi-Fi sensing technologies in everyday environments are enhanced. The primary applications include device-free sensing scenarios such as localization, tracking, motion detection, activity recognition, vital sign monitoring, and object imaging.

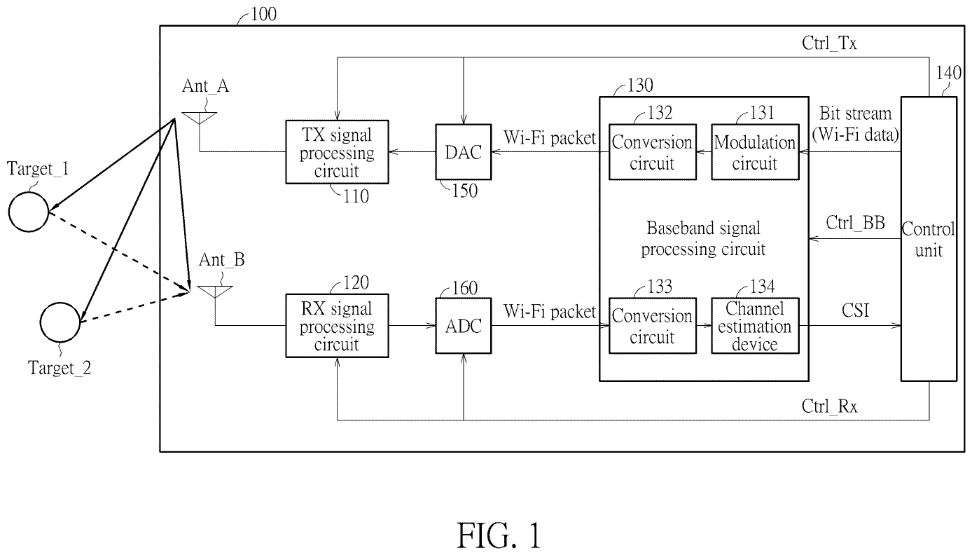

FIG. 1 is a block diagram illustrating an example of a communication device 100 according to a first embodiment of the present invention. The communication device 100 may include at least one independent transmitting (TX) chain and at least one independent receiving (RX) chain. Specifically, the communication device 100 may include an antenna Ant_A configured on the TX chain, a TX signal processing circuit 110, a digital-to-analog converter (DAC) 150, an antenna Ant_B configured on the RX chain, an RX signal processing circuit 120, an analog-to-digital converter (ADC) 160, a baseband signal processing circuit 130, and a control unit 140. In this embodiment, the communication device 100 may be a Wi-Fi device with 1Tx1R, wherein “T” represents TX, and “R” represents RX.

According to an embodiment of the present invention, during the process of transmitting signals, the control unit 140 may generate a bit stream to be transmitted (i.e., Wi-Fi data, hereinafter referred to as “bit stream data”), and provide the bit stream data to the baseband signal processing circuit 130. The baseband signal processing circuit 130 may include a modulation circuit 131 and a conversion circuit 132. The modulation circuit 131 is arranged to modulate the bit stream data in order to generate a modulation signal, wherein the modulation signal is a frequency-domain signal. The conversion circuit 132 is arranged to perform a frequency-to-time domain conversion operation upon the modulation signal in order to generate a time-domain digital signal.

According to an embodiment of the present invention, the modulation circuit 131 may be an orthogonal frequency-division multiplexing (OFDM) signal processing circuit that can generate a modulation signal with a Wi-Fi OFDM format according to the bit stream data. The conversion circuit 132 may be an inverse Fast Fourier Transform (iFFT) circuit that can perform an iFFT, and the time-domain digital signal generated by the conversion circuit 132 may include at least one Wi-Fi packet to be transmitted.

The DAC 150 may convert the time-domain digital signal into a time-domain analog signal for being provided to the TX signal processing circuit 110. The TX signal processing circuit 110 may include at least one mixer, a filter, and an amplifier. The mixer is arranged to convert the time-domain analog signal (which is typically a baseband signal) into a radio frequency (RF) signal. The filter is arranged to perform a filtering operation upon the RF signal in order to remove unwanted components (e.g., mirror signals or interference signals). The amplifier is arranged to amplify the RF signal for transmitting to a radio interface via the antenna Ant_A.

During the process of receiving signals, the RX signal processing circuit 120 may receive an RF signal via the antenna Ant_B. The RX signal processing circuit 120 may include at least one mixer, a filter, and an amplifier. The amplifier is arranged to amplify the RF signal. The filter is arranged to perform a filtering operation upon the RF signal in order to remove unwanted components (e.g., mirror signals or interference signals). The mixer is arranged to convert the RF signal into a baseband signal, wherein the baseband signal is a time-domain analog signal. The ADC 160 is arranged to convert the time-domain analog signal into a time-domain digital signal for being provided to the baseband signal processing circuit 130. According to an embodiment of the present invention, the time-domain digital signal may include at least one Wi-Fi packet.

The baseband signal processing circuit 130 may further include a conversion circuit 133 and a channel estimation device 134. The conversion circuit 133 is arranged to perform a time-to-frequency domain conversion operation upon the time-domain digital signal in order to generate a frequency-domain baseband signal. According to an embodiment of the present invention, the conversion circuit 133 may be a Fast Fourier Transform (FFT) circuit. The channel estimation device 134 is arranged to perform a channel estimation operation upon the frequency-domain baseband signal in order to generate channel information. For example, the channel estimation device 134 may estimate channel state information (CSI) according to the preamble part of the frequency-domain baseband signal.

In embodiments of the present invention, the communication

device 100 may operate in at least two different operating modes, such as a communication mode and a sensing mode. FIG. 1 illustrates an example architecture for performing mono-static sensing using a 1Tx1R Wi-Fi communication device. In embodiments of the present invention, the mode selection can be configured either statically or dynamically on a per-packet (or multiple packets) basis. In the communication mode, the TX signal processing circuit 110 and the RX signal processing circuit 120 (or the TX chain and the RX chain) operate in a half-duplex manner. When the TX chain and the RX chain of the communication device 100 operate in the half-duplex manner, the communication device 100 is in either a TX state or an RX state. That is, only one of the TX chain and the RX chain is used at the same time.

Specifically, when the communication device 100 is in the TX state, only the TX chain is used. At this moment, devices on the TX chain as well as devices within the baseband signal processing circuit 130 and the control unit 140 that correspond to TX signal processing may perform operations related to TX signal processing as described above. When the communication device 100 is in the RX state, only the RX chain is used. At this moment, devices on the RX chain as well as devices within the baseband signal processing circuit 130 and the control unit 140 that correspond to RX signal processing may perform operations related to RX signal processing as described above.

In the sensing mode, the communication device 100 performs mono-static sensing, and the TX signal processing circuit 110 and the RX signal processing circuit 120 (or the TX chain and the RX chain) operate in a full-duplex manner. When the TX chain and the RX chain of the communication device 100 operate in the full-duplex manner, the communication device 100 is in the TX state and the RX state at the same time. That is, when the communication device 100 is in the sensing mode, both the TX chain and the RX chain are used, and their operation or usage times may overlap.

According to an embodiment of the present invention, the control unit 140 may generate a corresponding control signal according to setting of different modes in order to enable a corresponding device (e.g., the TX signal processing circuit 110 or the RX signal processing circuit 120). In addition, the control unit 140 may control the TX power according to setting of different modes in order to meet the TX power requirements of each mode. According to an embodiment of the present invention, the control unit 140 may receive the CSI reported by the baseband signal processing circuit 130, and perform digital signal processing upon the CSI in order to generate a corresponding sensing result. For example, the control unit 140 may determine an object characteristic within the wireless communication environment where the communication device 100 is located.

The following paragraph will provide detailed descriptions of control and operations of the communication device 100 in the communication mode and the sensing mode.

In the communication mode, when the communication device 100 requires transmitting packets according to requirements or Wi-Fi TX protocols, the control unit 140 may generate bit stream data to be transmitted, and provide the bit stream data to the baseband signal processing circuit 130. In addition, the control unit 140 may generate a control signal Ctrl_BB in order to control the baseband signal processing circuit 130 to perform operations associated with the TX signal processing. For example, the modulation circuit 131 may generate a modulation signal with a Wi-Fi OFDM format according to the bit stream data, and the conversion circuit 132 may correspondingly generate a time-domain digital signal.

In addition, the control unit 140 may generate a control signal Ctrl_Tx in order to enable devices on the TX chain (e.g., the DAC 150 and the TX signal processing circuit 110), and control the devices on the TX chain to perform operations associated with the TX signal processing. For example, the DAC 150 may convert the time-domain digital signal into a time-domain analog signal, and the TX signal processing circuit 110 may perform corresponding operations such as mixing (e.g., up-conversion), filtering, and amplification, and transmit the RF signal to the radio interface via the antenna Ant_A. According to an embodiment of the present invention, the control unit 140 may control the TX power of each packet individually to meet the Wi-Fi TX requirements.

In addition, when the communication device 100 requires

transmitting packets or is in the TX state, the control unit 140 may generate a control signal Ctrl_Rx in order to close or disable devices on the RX chain (e.g., the RX signal processing circuit 120 and the ADC 160), or control the devices on the RX chain to enter a standby mode. That is, in the communication mode, the TX chain and the RX chain of the communication device 100 operate in the half-duplex manner.

When the communication device 100 requires receiving packets according to requirements or Wi-Fi TX protocols, the control unit 140 may generate the control signal Ctrl_Rx in order to enable devices on the RX chain, and generate the control signal Ctrl_BB in order to control the baseband signal processing circuit 130 to perform operations associated with the RX signal processing. In addition, the control unit 140 may generate the control signal Ctrl_Tx in order to close or disable devices on the TX chain, or control the devices on the TX chain to enter a standby mode. That is, in the communication mode, the TX chain and the RX chain of the communication device 100 operate in the half-duplex manner.

In embodiments of the present invention, the control unit 140 (or control units in the following figures) may set the control signals Ctrl_Tx, Ctrl_Rx and Ctrl_BB as different voltage levels in order to enable or disable corresponding devices.

The control unit 140 may control the RX signal processing circuit 120 to perform corresponding operations such as mixing (e.g., down-conversion), filtering, and amplification upon the received RF signal for generating a time-domain analog signal, control the ADC 160 to convert the time-domain analog signal into a time-domain digital signal, and control the baseband signal processing circuit 130 to prepare for receiving and processing the packets. For example, the conversion circuit 133 may perform a time-to-frequency domain conversion upon the received time-domain signal in order to generate a frequency-domain signal, wherein the frequency-domain signal is a frequency-domain baseband signal. The channel estimation device 134 may perform a channel estimation operation according to the frequency-domain signal in order to generate channel information. In the communication mode, the channel information may be used to de-modulate the Wi-Fi data carried in the received packet.

In the sensing mode, the control unit 140 may generate bit stream data for sensing, and provide the bit stream data to the baseband signal processing circuit 130. In addition, the control unit 140 may generate the control signal Ctrl_BB in order to control the baseband signal processing circuit 130 to perform operations associated with the TX signal processing. For example, the baseband signal processing circuit 130 may generate a predetermined packet provided to the TX signal processing circuit 110 according to the bit stream data. The modulation circuit 131 may generate a modulation signal with a Wi-Fi OFDM format according to the bit stream data, and the conversion circuit 132 may correspondingly generate a time-domain digital signal. According to an embodiment of the present invention, the time-domain digital signal may include the predetermined packet, and the predetermined packet carries the bit stream data generated by the control unit 140.

In addition, the control unit 140 may generate the control signal Ctrl_Tx in order to enable devices on the TX chain (e.g., the DAC 150 and the TX signal processing circuit 110), and control the devices on the TX chain to perform operations associated with the TX signal processing. For example, the DAC 150 may convert the time-domain digital signal into a time-domain analog signal, and the TX signal processing circuit 110 may perform corresponding operations such as mixing (e.g., up-conversion), filtering, and amplification, and transmit the RF signal to the radio interface via the antenna Ant_A.

According to an embodiment of the present invention, the RF signal may include the above-mentioned predetermined packet. In addition, the control unit 140 may control the TX power of the predetermined packet in order to meet both the Wi-Fi TX requirements and the mono-static sensing requirements. For example, the TX power of the predetermined packet is associated with the sensing distance or the sensing range, and the control unit 140 may set the TX power according to the required sensing distance or sensing range.

In addition, in the sensing mode, the control unit 140 may generate the control signal Ctrl_Rx in order to enable devices on the RX chain, and generate the control signal Ctrl_BB in order to control the baseband signal processing circuit 130 to perform operations associated with the RX signal processing. Specifically, the control unit 140 may control the RX signal processing circuit 120 to receive an RF signal via the antenna Ant_B, wherein the RF signal includes a received packet (e.g., a first packet) originating from the predetermined packet.

In this disclosure, the term “received packet originating from the predetermined packet” refers to a packet that is received by the RX signal processing circuit via an antenna in response to the transmission of the predetermined packet. In addition, the term “received packet originating from the predetermined packet” also refers to a packet that is received back by the communication device after the predetermined packet is transmitted by the communication device and is propagated through one or more paths (including reflection, diffraction, and refraction). Furthermore, the term “received packet originating from the predetermined packet” may also refer to a packet that is received back by the communication device after the predetermined packet is transmitted by the communication device and has undergone the channel response of the wireless TX path (e.g., experiencing corresponding time delay, as well as amplitude or phase variation). It should be noted that the above descriptions of the term “received packet originating from the predetermined packet” are applicable to all embodiments of the present invention and are therefore not limited to the first embodiment.

For clarity, in FIG. 1 and subsequent figures, solid arrows pointing away from one or more antennas represent RF signal TX paths, while dashed arrows pointing toward one or more antennas represent RF signal RX paths. As shown in FIG. 1, the wireless communication environment may include one or more target objects, such as target objects Target_1 and Target_2. After the RF signal carrying the predetermined packet for sensing is transmitted via the antenna Ant_A, the RF signal may propagate through one or more paths, such as paths directed toward the target objects Target_1 and Target_2, as well as reflected paths resulting from collisions with the target objects Target_1 and Target_2, and may subsequently be received by the antenna Ant_B.

In the sensing mode, the control unit 140 may control the RX signal processing circuit 120 to perform corresponding operations such as mixing (e.g., down-conversion), filtering, and amplification upon the received RF signal, and generate a time-domain analog signal. The control unit 140 may further control the ADC 160 to convert the time-domain analog signal into a time-domain digital signal, and control the baseband signal processing circuit 130 to prepare for receiving and processing the packet from the RX signal processing circuit 120 and the ADC 160. For example, the conversion circuit 133 may perform a time-to-frequency domain transformation operation upon the time-domain signal including the received packet in order to generate a frequency-domain signal, which may be a frequency-domain baseband signal. The channel estimation device 134 may perform a channel estimation operation according to the frequency-domain signal in order to generate channel information. In the sensing mode, the control unit 140 may determine an object characteristic within the wireless communication environment based on the channel information. For example, the control unit 140 may perform object presence detection, object positioning (localization), object tracking, object motion detection, object activity recognition, object vital sign monitoring, and object imaging.

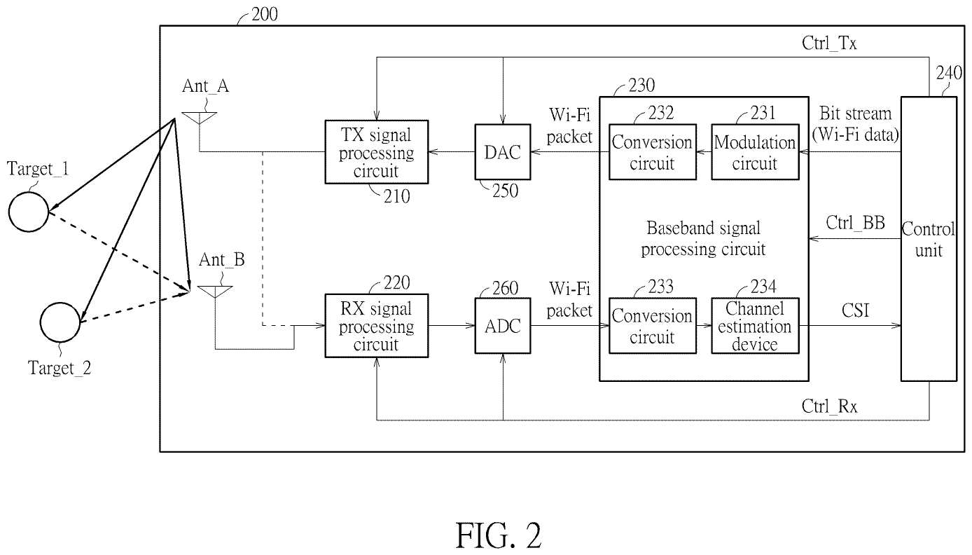

FIG. 2 is a block diagram illustrating an example of a communication device 200 according to a second embodiment of the present invention. The communication device 200 may include at least one independent TX chain and at least one independent RX chain. Specifically, the communication device 200 may include antennas Ant_A and Ant_B, a TX signal processing circuit 210 and a DAC 250 configured on the TX chain, an RX signal processing circuit 220 and an ADC 260 configured on the RX chain, a baseband signal processing circuit 230, and a control unit 240.

The communication device 200 may operate in at least two different operating modes, such as a communication mode and a sensing mode. In the communication mode, both the TX signal processing circuit 210 and the RX signal processing circuit 220 (or the corresponding TX chain and RX chain) operate cooperatively in a half-duplex manner. In the sensing mode, the communication device 200 performs mono-static sensing, and both the TX signal processing circuit 210 and the RX signal processing circuit 220 (or the corresponding TX chain and RX chain) operate in a full-duplex manner. As a result, when the communication device 200 is in the sensing mode, both the TX chain and the RX chain are used, and their operation or usage times may overlap.

Similar to operations of the communication device 100, in the communication mode, when the communication device 200 requires transmitting packets, the control unit 240 may generate bit stream data to be transmitted, and provide the bit stream data to the baseband signal processing circuit 230. In addition, the control unit 240 may generate a control signal Ctrl_BB for controlling the baseband signal processing circuit 230 to perform operations associated with TX signal processing. For example, the modulation circuit 231 may generate a modulation signal with a Wi-Fi OFDM format according to the inputted bit stream data, and the conversion circuit 232 may correspondingly generate a time-domain digital signal.

In addition, the control unit 240 may generate a control signal Ctrl_Tx for enabling devices on the TX chain (e.g., the DAC 250 and the TX signal processing circuit 210) and controlling the devices on the TX chain to perform operations associated with TX signal processing. For example, the DAC 250 may convert the time-domain digital signal into a time-domain analog signal. The TX signal processing circuit 210 may perform corresponding operations such as mixing (e.g., up-conversion), filtering, and amplification, and transmit the RF signal to the radio interface via the antenna Ant_A. According to an embodiment of the present invention, the control unit 240 may control the TX power of each packet individually in order to meet Wi-Fi transmission requirements.

In addition, when the communication device 200 requires transmitting packets or is in the TX state, the control unit 240 may generate a control signal Ctrl_Rx in order to close or disable devices on the RX chain (e.g., the RX signal processing circuit 220 and the ADC 260), or control the devices on the RX chain to enter a standby mode. That is, in the communication mode, the TX chain and the RX chain of the communication device 200 operate in the half-duplex manner.

When the communication device 200 requires receiving packets, the control unit 240 may generate the control signal Ctrl_Rx in order to enable devices on the RX chain, and generate the control signal Ctrl_BB in order to control the baseband signal processing circuit 230 to perform operations associated with the RX signal processing. In addition, the control unit 240 may generate the control signal Ctrl_Tx in order to close or disable devices on the TX chain, or control the devices on the TX chain to enter a standby mode. That is, in the communication mode, the TX chain and the RX chain of the communication device 200 operate in the half-duplex manner.

The control unit 240 may control the RX signal processing circuit 220 to perform corresponding operations such as mixing (e.g., down-conversion), filtering, and amplification upon the received RF signal for generating a time-domain analog signal, control the ADC 260 to convert the time-domain analog signal into a time-domain digital signal, and control the baseband signal processing circuit 230 to prepare for receiving and processing the packets. For example, the conversion circuit 233 may perform a time-to-frequency domain conversion upon the received time-domain signal in order to generate a frequency-domain signal, wherein the frequency-domain signal is a frequency-domain baseband signal. The channel estimation device 234 may perform a channel estimation operation according to the frequency-domain signal in order to generate channel information. In the communication mode, the channel information may be used to de-modulate the Wi-Fi data carried in the received packet.

In the sensing mode, the control unit 240 may generate bit stream data for sensing, and provide the bit stream data to the baseband signal processing circuit 230. In addition, the control unit 240 may generate the control signal Ctrl_BB in order to control the baseband signal processing circuit 230 to perform operations associated with the TX signal processing. For example, the baseband signal processing circuit 230 may generate a predetermined packet that is provided to the TX signal processing circuit 210 according to the bit stream data. The modulation circuit 231 may generate a modulation signal with a Wi-Fi OFDM format according to the bit stream data, and the conversion circuit 232 may correspondingly generate a time-domain digital signal. According to an embodiment of the present invention, the time-domain digital signal may include the predetermined packet, and the predetermined packet carries the bit stream data generated by the control unit 240.

In addition, the control unit 240 may generate the control signal Ctrl_Tx in order to enable devices on the TX chain (e.g., the DAC 250 and the TX signal processing circuit 210), and control the devices on the TX chain to perform operations associated with the TX signal processing. For example, the DAC 250 may convert the time-domain digital signal into a time-domain analog signal, and the TX signal processing circuit 110 may perform corresponding operations such as mixing (e.g., up-conversion), filtering, and amplification, and transmit the RF signal to the radio interface via the antenna Ant_A.

According to an embodiment of the present invention, the RF signal may include the above-mentioned predetermined packet. In addition, the control unit 240 may control the TX power of the predetermined packet in order to meet both the Wi-Fi TX requirements and the mono-static sensing requirements. For example, the TX power of the predetermined packet is associated with the sensing distance or the sensing range, and the control unit 240 may set the TX power according to the required sensing distance or sensing range.

In addition, in the sensing mode, the control unit 240 may generate the control signal Ctrl_Rx in order to enable devices on the RX chain, and generate the control signal Ctrl_BB in order to control the baseband signal processing circuit 230 to perform operations associated with the RX signal processing. Specifically, the control unit 240 may control the RX signal processing circuit 220 to receive an RF signal via the antenna Ant_B, wherein the RF signal includes a received packet originating from the predetermined packet.

In the sensing mode, the control unit 240 may control the RX signal processing circuit 220 to perform corresponding operations such as mixing (e.g., down-conversion), filtering, and amplification upon the received RF signal, and generate a time-domain analog signal. The control unit 140 may further control the ADC 260 to convert the time-domain analog signal into a time-domain digital signal, and control the baseband signal processing circuit 230 to prepare for receiving and processing the packet from the RX signal processing circuit 220 and the ADC 260. For example, the conversion circuit 233 may perform a time-to-frequency domain transformation operation upon the time-domain signal including the received packet in order to generate a frequency-domain signal, which may be a frequency-domain baseband signal. The channel estimation device 234 may perform a channel estimation operation according to the frequency-domain signal in order to generate channel information.

In the sensing mode, the control unit 240 may determine an object characteristic within the wireless communication environment based on the channel information. For example, the control unit 240 may perform object presence detection, object positioning (localization), object tracking, object motion detection, object activity recognition, object vital sign monitoring, and object imaging.

FIG. 2 also illustrates architecture for performing mono-static sensing by a 1Tx1R Wi-Fi communication device. The operations of components included in the communication device 200 are generally the same as those of the communication device 100 in the first embodiment. As a result, the components and operations of the communication device 200 are only briefly described in the above paragraph. For detailed descriptions of the operations of the components within the communication device 200 in different modes, refer to the relevant sections of FIG. 1, which will not be repeated here.

The difference between the first embodiment and the second embodiment is that, in the second embodiment, the antenna Ant_A may be an antenna shared by the TX chain and the RX chain. In the communication mode, the communication device 200 may select the antennas Ant_A or Ant_B to receive the RF signal. In the sensing mode, the communication device 200 may transmit the RF signal including the predetermined packet via the antenna Ant_A, and receive the RF signal via the antenna Ant_B. In other words, in the sensing mode, the antenna Ant_A is dedicated to transmitting the RF signal including the predetermined packet, and the antenna Ant_B is dedicated to receiving the RF signal including a received packet originating from the predetermined packet. In this way, the antenna Ant_B and the corresponding pins or amplifiers can be designed more appropriately according to the sensing application.

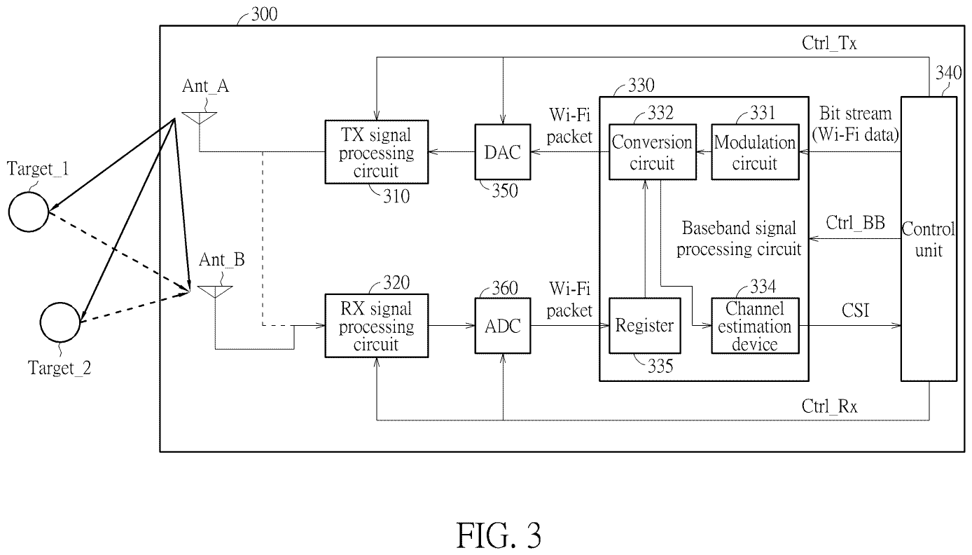

FIG. 3 is a block diagram illustrating an example of a communication device 300 according to a third embodiment of the present invention. FIG. 3 similarly illustrates architecture for performing mono-static sensing by a 1Tx1R Wi-Fi communication device. The operations of components included in the communication device 300 are generally the same as those of the communication device 100 of the first embodiment (or the communication device 200 of the second embodiment). Therefore, detailed descriptions of the components within communication device 300, such as a TX signal processing circuit 310, an RX signal processing circuit 320, a baseband signal processing circuit 330, a modulation circuit 331, a conversion circuit 332, a channel estimation device 334, a control unit 340, a DAC 350, and an ADC 360, can be found in the descriptions of the corresponding components in FIGS. 1 and 2, and will not be repeated here. In addition, the operations of the communication device 300 in the communication mode and the sensing mode can also be known by referring to the relevant sections of FIGS. 1 and 2, and will not be repeated here.

The difference between the third embodiment and the first/second embodiment is that, in the third embodiment, the same conversion circuit 332 is shared by the TX chain and the RX chain. As a result, the conversion circuit 332 may be a conversion circuit capable of performing the FFT and the iFFT. Considering that the communication device typically operates in a half-duplex manner during the communication mode (i.e., transmission and reception do not occur simultaneously), sharing the same conversion circuit between the TX chain and the RX chain can effectively reduce hardware cost. It should be noted that the conversion circuits 132, 133, 232, and 233 in the first and second embodiments may also be conversion circuits capable of performing the FFT and the iFFT.

In the third embodiment, the baseband signal processing circuit 330 may further include a register 335. The register 335 may be arranged to temporarily store a received packet in the sensing mode. For example, when resources of the conversion circuit 332 are occupied to perform a frequency-to-time domain conversion operation upon the modulation signal, the register 335 may temporarily store the received packet provided to the baseband signal processing circuit 330 by the RX chain. After the resources of the conversion circuit 332 are released, the conversion circuit 332 may obtain the received packet from the register 335, and perform a time-to-frequency domain conversion operation upon the received packet in order to generate a frequency-domain baseband signal for channel estimating.

In embodiments of the present invention, a TX chain and an RX chain that can operate cooperatively in a half-duplex manner may form a transceiver circuit. FIGS. 1 to 3 illustrate different embodiments of a communication device that performs mono-static sensing by a transceiver circuit, but the present invention is not limited thereto. In some embodiments, the communication device may also perform mono-static sensing by using more than one transceiver circuits.

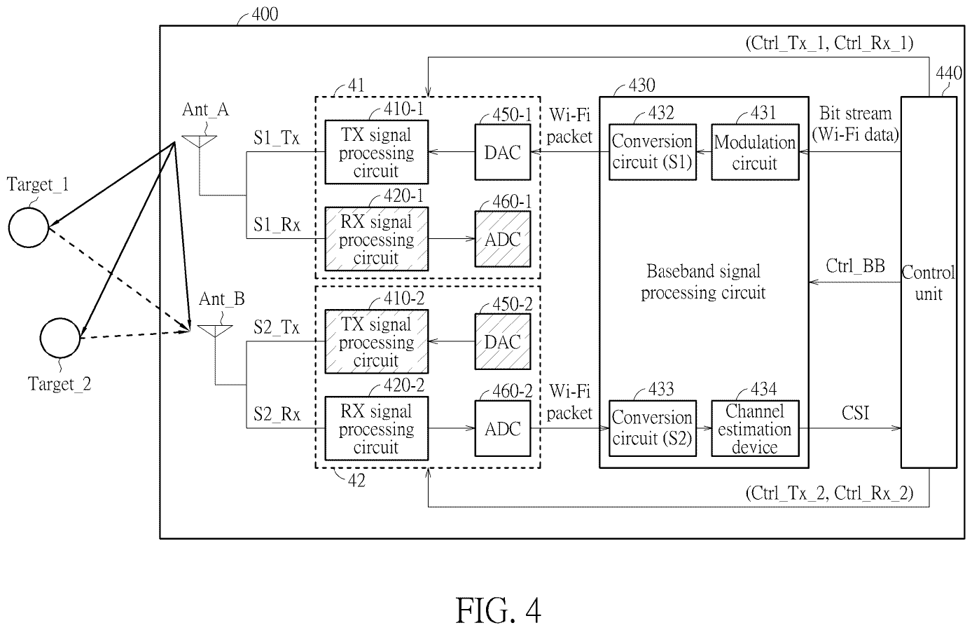

FIG. 4 is a block diagram illustrating an example of a communication device 400 according to a fourth embodiment of the present invention. The communication device 400 may include antennas Ant_A and Ant_B, front-end signal processing circuits 41 and 42, a baseband signal processing circuit 430, and a control unit 440. In the fourth embodiment, the communication device 400 may include at least two independent TX chains and at least two independent RX chains.

The front-end signal processing circuit 41 may include a TX signal processing circuit 410-1, a DAC 450-1, an RX signal processing circuit 420-1, and an ADC 460-1, and may further include the antenna Ant_A configured on a TX chain S1_Tx and the antenna Ant_A configured on an RX chain S1_Rx.

The front-end signal processing circuit 42 may include a TX signal processing circuit 410-2, a DAC 450-2, an RX signal processing circuit 420-2, and an ADC 460-2, and may further include the antenna Ant_B configured on a TX chain S2_Tx and the antenna Ant_B configured on an RX chain S2_Rx.

In the fourth embodiment, the front-end signal processing circuit 41 may be a first transceiver circuit S1, and the front-end signal processing circuit 42 may be a second transceiver circuit S2. As a result, the communication device 400 may be a 2Tx2R Wi-Fi communication device. The front-end signal processing circuits 41 and 42 may form a multiple-input multiple output (MIMO) system, and the communication device 400 may use the two transceiver circuits for performing MIMO communications.

The communication device 400 may operate in at least two different operating modes, such as a communication mode and a sensing mode. In the communication mode, the TX chain S1_Tx and the RX chain S1_Rx operate cooperatively in a half-duplex manner and the TX chain S2_Tx and the RX chain S2_Rx operate cooperatively in the half-duplex manner. In the sensing mode, the communication device 400 performs mono-static sensing, and both the TX chain S1_Tx and the RX chain S2_Rx (or both the TX chain S2_Tx and the RX chain S1_Rx) operate in a full-duplex manner. As a result, in the sensing mode, both the TX chain and the RX chain are used, and their operation or usage times may overlap.

In the communication mode, when the communication device 400 requires transmitting packets, the control unit 440 may generate a control signal Ctrl_BB in order to control the baseband signal processing circuit 430 to perform operations associated with TX signal processing. In addition, the control unit 440 may generate control signals Ctrl_Tx_1 and Ctrl_Tx_2 in order to enable devices on the TX chains S1_Tx and S2_Tx.

In addition, when the communication device 400 requires transmitting packets or is in a TX state, the control unit 440 may generate control signals Ctrl_Rx_1 and Ctrl_Rx_2 in order to close or disable devices on the RX chains S1_Rx and S2_Rx, or control the devices on the RX chains S1_Rx and S2_Rx to enter a standby mode.

When the communication device 400 requires receiving packets, the control unit 440 may generate the control signal Ctrl_BB in order to control the baseband signal processing circuit 430 to perform operations associated with RX signal processing. In addition, the control unit 440 may generate the control signals Ctrl_Rx_1 and Ctrl_Rx_2 in order to enable the devices on the RX chains S1_Rx and S2_Rx.

In addition, when the communication device 400 requires receiving packets or is in an RX state, the control unit 440 may generate the control signals Ctrl_Tx_1 and Ctrl_Tx_2 in order to close or disable the devices on the TX chains S1_Tx and S2_Tx, or control the devices on the TX chains S1_Tx and S2_Tx to enter a standby mode. In this way, in the communication mode, the two transceiver circuits included in the communication device 400 can operate in a half-duplex manner.

In embodiments of the present invention, the control units 440 (or control units in the following figures) may set the control signals Ctrl_Tx_1, Ctrl_Tx_2, Ctrl_Rx_1, Ctrl_Rx_2, and Ctrl_BB as different voltage levels in order to enable or disable corresponding devices.

In the communication mode, the operations of components included in the communication device 400 (e.g., the TX signal processing circuits 410-1 and 410-2, the RX signal processing circuits 420-1 and 420-2, the DACs 450-1 and 450-2, the ADCs 460-1 and 460-2, the baseband signal processing circuit 430, and the control unit 440) are generally the same as those in the communication device 100 of the first embodiment. Therefore, detailed descriptions of the components within communication device 400 can be found in the descriptions of the corresponding components in FIG. 1, and will not be repeated here.

In an embodiment of the present invention, the baseband signal processing circuit 430 may include two baseband circuits, wherein each baseband circuit may correspond to a transceiver circuit, and may include one or more of a modulation circuit, a conversion circuit, and a channel estimation device for performing corresponding baseband signal processing. In order to simplify the illustration and facilitate the description of operations in the sensing mode, FIG. 4 only shows a portion of the baseband signal processing circuit 430.

In other words, certain portions of the baseband signal processing circuit 430 are omitted in FIG. 4, and therefore some connections between devices are also not shown in FIG. 4. Those skilled in the art can infer the omitted portions of FIG. 4 based on the circuits and the device connections disclosed in other embodiments. Furthermore, details regarding the components included in each baseband circuit and their operation in the communication mode can be known by referring to the relevant sections of FIG. 1, which will not be repeated here.

FIG. 4 illustrates architecture where a 2Tx2R Wi-Fi communication device performs 1Tx1R mono-static sensing. It should be noted that the components filled with diagonal lines in FIG. 4 are disabled or closed in the sensing mode, but the present invention is not limited thereto.

In the sensing mode, the control unit 440 may select a TX chain in a transceiver circuit and an RX chain in another transceiver circuit for sensing. For example, the control unit 440 may generate the control signal Ctrl_Tx_1 in order to enable devices on the TX chain S1_Tx, and generate the control signal Ctrl_Rx_1 in order to close or disable devices on the RX chain S1_Rx. Similarly, the control unit 440 may generate the control signal Ctrl_Tx_2 in order to close or disable devices on the TX chain S2_Tx, and generate the control signal Ctrl_Rx_2 in order to enable devices on the RX chain S2_Rx.

The control unit 440 may generate bit stream data for sensing, and provide the bit stream data to the baseband signal processing circuit 430. In addition, the control unit 440 may generate the control signal Ctrl_BB in order to control the baseband signal processing circuit 430 to perform operations associated with TX signal processing. For example, the baseband signal processing circuit 430 may generate a predetermined packet for sensing according to the bit stream data, and provide the predetermined packet to the TX signal processing circuit 410-1.

Specifically, the modulation circuit 431 may generate a modulation signal with a Wi-Fi OFDM format according to the bit stream data, and the conversion circuit 432 may correspondingly generate a time-domain digital signal. For example, the conversion circuit 432 may be a conversion circuit corresponding to the first transceiver circuit S1, and may perform the iFFT. According to an embodiment of the present invention, the time-domain digital signal may include the predetermined packet, and the predetermined packet carries the bit stream data.

The DAC 450-1 may convert the time-domain digital signal into a time-domain analog signal. The TX signal processing circuit 410-1 may perform corresponding operations such as mixing (e.g., up-conversion), filtering, and amplification, and transmit the RF signal to the radio interface via the antenna Ant_A.

According to an embodiment of the present invention, the RF signal may include the predetermined packet for sensing. In addition, the control unit 440 may control the TX power of the predetermined packet in order to meet both the Wi-Fi TX requirements and the mono-static sensing requirements. For example, the TX power of the predetermined packet is associated with the sensing distance or the sensing range, and the control unit 440 may set the TX power according to the required sensing distance or sensing range.

Regarding RX signal processing, in the sensing mode, the control unit 440 may control the RX signal processing circuit 420-2 to receive an RF signal via the antenna Ant_B, wherein the RF signal includes a received packet originating from the predetermined packet. The RX signal processing circuit 420-2 may perform corresponding operations such as mixing (e.g., down-conversion), filtering, and amplification upon the received RF signal in order to generate a time-domain analog signal. The ADC 460-2 may convert the time-domain analog signal into a time-domain digital signal.

In addition, the control unit 440 may generate the control signal Ctrl_BB in order to control the baseband signal processing circuit 430 to prepare for receiving and processing the packets. For example, the conversion circuit 433 may perform a time-to-frequency domain conversion upon the received time-domain signal in order to generate a frequency-domain signal, wherein the conversion circuit 433 may correspond to the second transceiver circuit S2, and may perform the FFT. The channel estimation device 434 may perform a channel estimation operation according to the frequency-domain signal in order to generate channel information for providing to the control unit 440.

In the sensing mode, the control unit 440 may determine an object characteristic within the wireless communication environment based on the channel information. For example, the control unit 440 may perform object presence detection, object positioning (localization), object tracking, object motion detection, object activity recognition, object vital sign monitoring, and object imaging.

In the fourth embodiment of the present invention, the conversion circuits 432 and 433 may respectively perform the FFT and the iFFT. For example, when the communication device 400 requires transmitting packets, the conversion circuit 432 and/or 433 may perform an iFFT in order to convert a modulated signal from the frequency domain to the time domain, thereby generating a time-domain digital signal. When the communication device 400 receives packets, the conversion circuit 432 and/or 433 may perform an FFT in order to convert the time-domain digital signal output from the front-end signal processing circuit into a frequency-domain baseband signal.

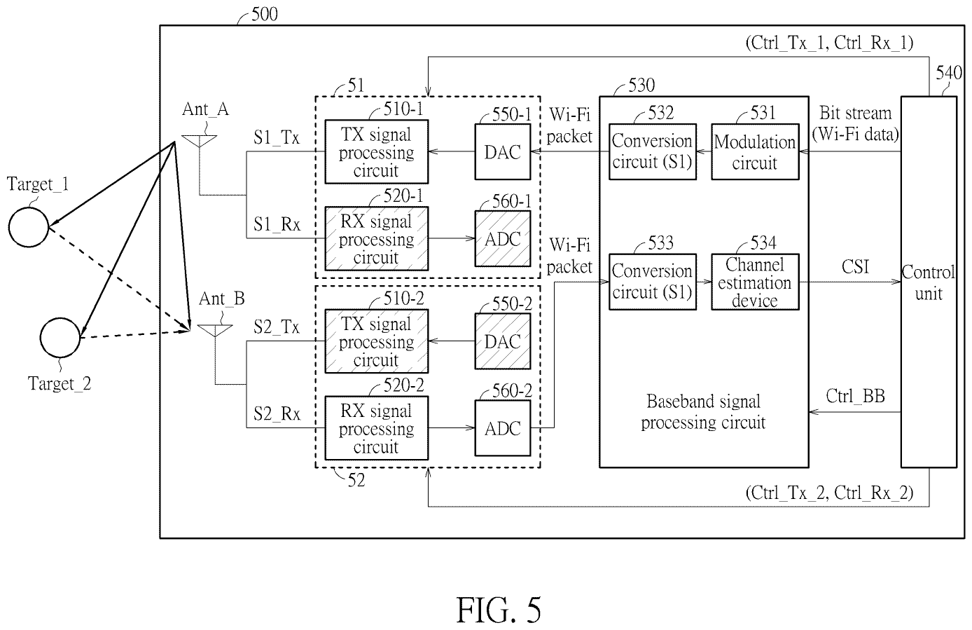

FIG. 5 is a block diagram illustrating an example of a communication device 500 according to a fifth embodiment of the present invention. The communication device 500 may include antennas Ant_A and Ant_B, front-end signal processing circuits 51 and 52, a baseband signal processing circuit 530, and a control unit 540. In the fifth embodiment, the communication device 500 may include at least two independent TX chains and at least two independent RX chains.

The front-end signal processing circuit 51 may include a TX signal processing circuit 510-1, a DAC 550-1, an RX signal processing circuit 520-1, and an ADC 560-1, and may further include the antenna Ant_A configured on a TX chain S1_Tx and the antenna Ant_A configured on an RX chain S1_Rx.

The front-end signal processing circuit 52 may include a TX signal processing circuit 510-2, a DAC 550-2, an RX signal processing circuit 520-2, and an ADC 560-2, and may further include the antenna Ant_B configured on a TX chain S2_Tx and the antenna Ant_B configured on an RX chain S2_Rx.

In the fifth embodiment, the front-end signal processing circuit 51 may be a first transceiver circuit S1, and the front-end signal processing circuit 52 may be a second transceiver circuit S2. As a result, the communication device 500 may be a 2Tx2R Wi-Fi communication device. The front-end signal processing circuits 51 and 52 may form an MIMO system, and the communication device 500 may use the two transceiver circuits for performing MIMO communications.

The communication device 500 may operate in at least two different operating modes, such as a communication mode and a sensing mode. In the communication mode, the TX chain S1_Tx and the RX chain S1_Rx operate cooperatively in a half-duplex manner and the TX chain S2_Tx and the RX chain S2_Rx operate cooperatively in the half-duplex manner. In the sensing mode, the communication device 500 performs mono-static sensing, and both the TX chain S1_Tx and the RX chain S2_Rx (or both the TX chain S2_Tx and the RX chain S1_Rx) operate in a full-duplex manner. As a result, in the sensing mode, both the TX chain and the RX chain are used, and their operation or usage times may overlap.

FIG. 5 illustrates architecture where a 2Tx2R Wi-Fi communication device performs 1Tx1R mono-static sensing. It should be noted that the components filled with diagonal lines in FIG. 5 are disabled or closed in the sensing mode, but the present invention is not limited thereto.

In the sensing mode, the control unit 540 may generate bit stream data for sensing, and provide the bit stream data to the baseband signal processing circuit 530. The modulation circuit 531 may generate a modulation signal with a Wi-Fi OFDM format according to the bit stream data, wherein the modulation signal is a frequency-domain signal. The conversion circuit 532 may perform a frequency-to-time domain conversion operation upon the modulation signal in order to generate a time-domain digital signal. According to an embodiment of the present invention, the time-domain digital signal may include a predetermined packet for sensing, and the predetermined packet carries the bit stream data generated by the control unit 540.

The control unit 540 may generate a control signal Ctrl_Tx_1 in order to enable the TX signal processing circuit 510-1 and the DAC 550-1 on the TX chain S1_Tx, and generate a control signal Ctrl_Rx_1 in order to close or disable the RX signal processing circuit 520-1 and the ADC 560-1 on the RX chain S1_Rx. Similarly, the control unit 540 may generate a control signal Ctrl_Tx_2 in order to close or disable the TX signal processing circuit 510-2 and the DAC 550-2 on the TX chain S2_Tx, and generate a control signal Ctrl_Rx_2 in order to enable the RX signal processing circuit 520-2 and the ADC 560-2 on the RX chain S2_Rx.

The DAC 550-1 may convert the time-domain digital signal including the predetermined packet into a time-domain analog signal, and the TX signal processing circuit 510-1 may perform corresponding operations such as mixing (e.g., up-conversion), filtering, and amplification, and transmit the RF signal including the predetermined packet to the radio interface via the antenna Ant_A.

According to an embodiment of the present invention, the control unit 540 may control the TX power of the predetermined packet in order to meet both the Wi-Fi TX requirements and the mono-static sensing requirements. For example, the TX power of the predetermined packet is associated with the sensing distance or the sensing range, and the control unit 540 may set the TX power according to the required sensing distance or sensing range.

Regarding RX signal processing, in the sensing mode, the RX signal processing circuit 520-2 may receive an RF signal via the antenna Ant_B, wherein the RF signal includes a received packet originating from the predetermined packet. The RX signal processing circuit 520-2 may perform corresponding operations such as mixing (e.g., down-conversion), filtering, and amplification upon the received RF signal in order to generate a time-domain analog signal. The ADC 560-2 may convert the time-domain analog signal into a time-domain digital signal.

The baseband signal processing circuit 530 may receive the time-domain digital signal including the received packet, and perform a time-to-frequency domain conversion upon the received time-domain signal via the conversion circuit 533 in order to generate a frequency-domain baseband signal. The channel estimation device 534 may perform a channel estimation operation according to the frequency-domain baseband signal in order to generate channel information for providing to the control unit 540.

In the sensing mode, the control unit 540 may determine an object characteristic within the wireless communication environment based on the channel information. For example, the control unit 540 may perform object presence detection, object positioning (localization), object tracking, object motion detection, object activity recognition, object vital sign monitoring, and object imaging.

The operations of components included in the communication device 500 are generally the same as those of the communication device 400 of the fourth embodiment. Therefore, detailed descriptions of the components within the communication device 500 can be found in the descriptions of the corresponding components in FIG. 4. In addition, for other controls and operations of the communication device 500 in the communication mode and the sensing mode that are not described herein, reference may be made to the relevant paragraphs associated with FIG. 4, and detailed descriptions are omitted here for brevity.

The difference between the fifth embodiment and the fourth embodiment is that, in the fifth embodiment, after the RX chain enters the baseband signal processing circuit 530, the conversion circuit 533 within the first transceiver circuit S1 is used, and an FFT is performed upon the time-domain signal including the received packet via the conversion circuit 533 in order to generate a frequency-domain signal. Afterwards, the channel estimation device 534 may perform a channel estimation operation according to the frequency-domain signal in order to generate channel information for providing to the control unit 540.

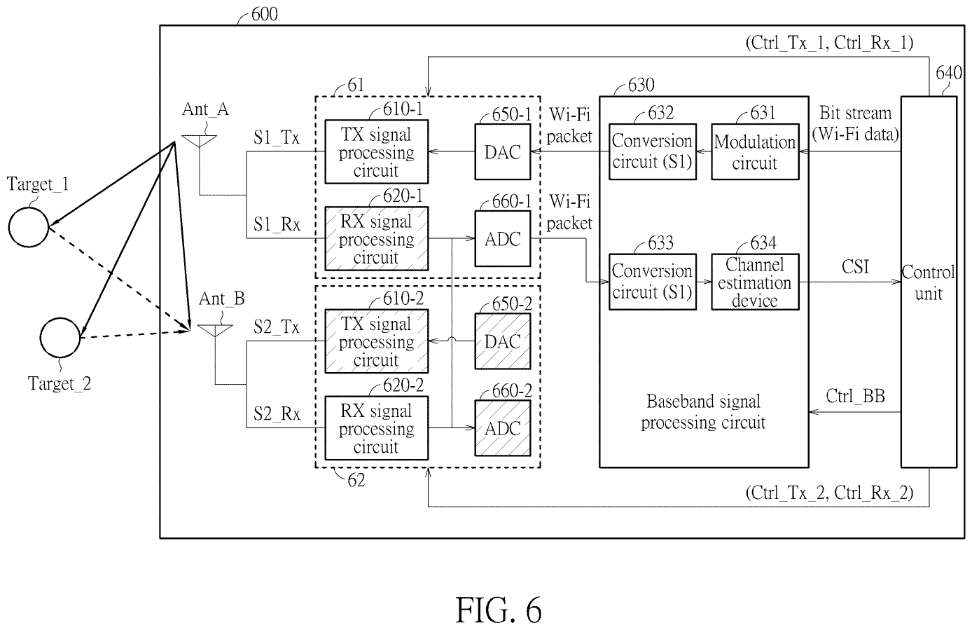

FIG. 6 is a block diagram illustrating an example of a communication device 600 according to a sixth embodiment of the present invention. The communication device 600 may include antennas Ant_A and Ant_B, front-end signal processing circuits 61 and 62, a baseband signal processing circuit 630, and a control unit 640. In the sixth embodiment, the communication device 600 may include at least two independent TX chains and at least two independent RX chains.

The front-end signal processing circuit 61 may include a TX signal processing circuit 610-1, a DAC 650-1, an RX signal processing circuit 620-1, and an ADC 660-1, and may further include the antenna Ant_A configured on a TX chain S1_Tx and the antenna Ant_A configured on an RX chain S1_Rx.

The front-end signal processing circuit 62 may include a TX signal processing circuit 610-2, a DAC 650-2, an RX signal processing circuit 620-2, and an ADC 660-2, and may further include the antenna Ant_B configured on a TX chain S2_Tx and the antenna Ant_B configured on an RX chain S2_Rx.

In the sixth embodiment, the front-end signal processing circuit 61 may be a first transceiver circuit S1, and the front-end signal processing circuit 62 may be a second transceiver circuit S2. As a result, the communication device 600 may be a 2Tx2R Wi-Fi communication device. The front-end signal processing circuits 61 and 62 may form an MIMO system, and the communication device 600 may use the two transceiver circuits for performing MIMO communications.

The communication device 600 may operate in at least two different operating modes, such as a communication mode and a sensing mode. In the communication mode, the TX chain S1_Tx and the RX chain S1_Rx operate cooperatively in a half-duplex manner, and the TX chain S2_Tx and the RX chain S2_Rx operate cooperatively in the half-duplex manner. In the sensing mode, the communication device 600 performs mono-static sensing, and both the TX chain S1_Tx and the RX chain S2_Rx (or both the TX chain S2_Tx and the RX chain S1_Rx) operate in a full-duplex manner. As a result, in the sensing mode, both the TX chain and the RX chain are used, and their operation or usage times may overlap.

FIG. 6 illustrates architecture where a 2Tx2R Wi-Fi communication device performs 1Tx1R mono-static sensing. It should be noted that the components filled with diagonal lines in FIG. 6 are disabled or closed in the sensing mode, but the present invention is not limited thereto.

In the sensing mode, the control unit 640 may generate bit stream data for sensing, and provide the bit stream data to the baseband signal processing circuit 630. The modulation circuit 631 may generate a modulation signal with a Wi-Fi OFDM format according to the bit stream data, wherein the modulation signal is a frequency-domain signal. The conversion circuit 632 may perform a frequency-to-time domain conversion operation upon the modulation signal in order to generate a time-domain digital signal. According to an embodiment of the present invention, the time-domain digital signal may include a predetermined packet for sensing, and the predetermined packet carries the bit stream data generated by the control unit 640.

The control unit 640 may generate a control signal Ctrl_Tx_1 in order to enable the TX signal processing circuit 610-1 and the DAC 650-1 on the TX chain S1_Tx, and generate a control signal Ctrl_Rx_1 in order to close or disable the RX signal processing circuit 620-1 on the RX chain S1_Rx. Similarly, the control unit 640 may generate a control signal Ctrl_Tx_2 in order to close or disable the TX signal processing circuit 610-2 and the DAC 650-2 on the TX chain S2_Tx.

The difference between the sixth embodiment and the fourth embodiment is that, in the sixth embodiment, the analog-to-digital conversion operation for the received signals in the sensing mode is modified to be performed by the ADC 660-1 within the front-end signal processing circuit 61. As a result, the RX signal processing circuit 620-2 may be further coupled to the ADC 660-1 within the front-end signal processing circuit 61. The control unit 640 may generate a control signal Ctrl_Rx_2 in order to enable the RX signal processing circuit 620-2 on the RX chain S2_Rx, and disable or close the ADC 660-2 on the RX chain S2_Rx. In addition, the control unit 640 may generate the control signal Ctrl_Rx_1 in order to enable the ADC 660-1 on the RX chain S1_Rx.

In embodiments of the present invention, the control signals Ctrl_Tx_1, Ctrl_Tx_2, Ctrl_Rx_1, and Ctrl_Rx_2 may be implemented as a set of control signals including multiple sub-control signals, and each sub-control signal may be arranged to control a corresponding device. The control units 640 (or control units in the following figures) may set the sub-control signals as different voltage levels in order to enable or disable corresponding devices.

The DAC 650-1 may convert the time-domain digital signal including the predetermined packet into a time-domain analog signal, and the TX signal processing circuit 610-1 may perform corresponding operations such as mixing (e.g., up-conversion), filtering, and amplification, and transmit the RF signal including the predetermined packet to the radio interface via the antenna Ant_A.

According to an embodiment of the present invention, the control unit 640 may control the TX power of the predetermined packet in order to meet both the Wi-Fi TX requirements and the mono-static sensing requirements. For example, the TX power of the predetermined packet is associated with the sensing distance or the sensing range, and the control unit 640 may set the TX power according to the required sensing distance or sensing range.

Regarding RX signal processing, in the sensing mode, the RX signal processing circuit 620-2 may receive an RF signal via the antenna Ant_B, wherein the RF signal includes a received packet originating from the predetermined packet. The RX signal processing circuit 620-2 may perform corresponding operations such as mixing (e.g., down-conversion), filtering, and amplification upon the received RF signal in order to generate a time-domain analog signal. The ADC 660-2 may convert the time-domain analog signal into a time-domain digital signal.

The baseband signal processing circuit 630 may receive the time-domain digital signal including the received packet, and perform a time-to-frequency domain conversion upon the received time-domain signal via the conversion circuit 633 in order to generate a frequency-domain signal. The channel estimation device 634 may perform a channel estimation operation according to the frequency-domain signal in order to generate channel information for providing to the control unit 640.

In the sensing mode, the control unit 640 may determine an object characteristic within the wireless communication environment based on the channel information. For example, the control unit 640 may perform object presence detection, object positioning (localization), object tracking, object motion detection, object activity recognition, object vital sign monitoring, and object imaging.

The operations of components included in the communication device 600 are generally the same as those of the communicationdevice 400 of the fourth embodiment. Therefore, detailed descriptions of the components within communication device 600 can be found in the descriptions of the corresponding components in FIG. 4. In addition, for other controls and operations of the communication device 600 in the communication mode and the sensing mode that are not described herein, reference may be made to the relevant paragraphs associated with FIG. 4, and detailed descriptions are omitted here for brevity.

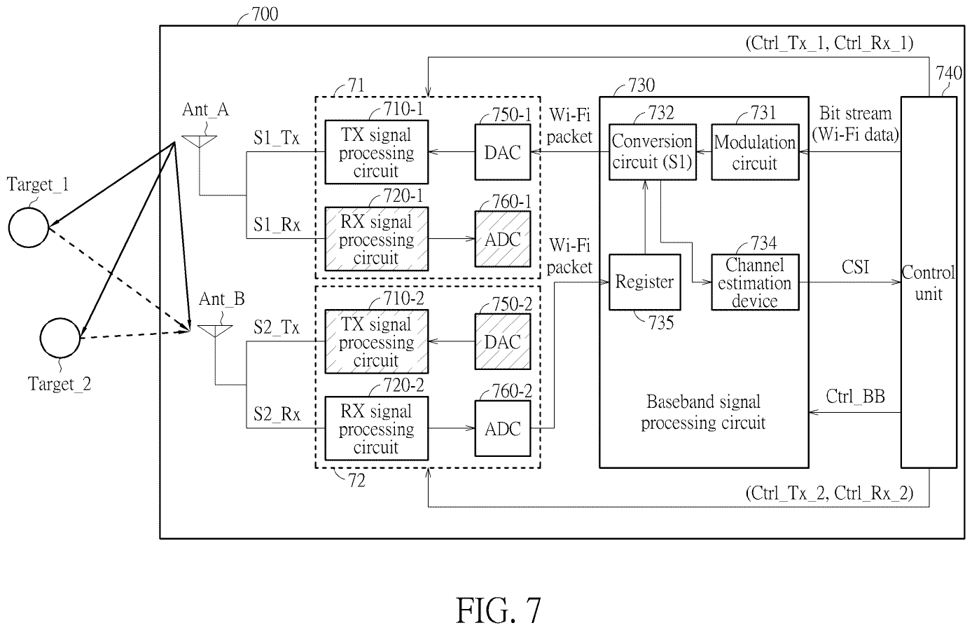

FIG. 7 is a block diagram illustrating an example of a communication device 700 according to a seventh embodiment of the present invention. The communication device 700 may include antennas Ant_A and Ant_B, front-end signal processing circuits 71 and 72, a baseband signal processing circuit 730, and a control unit 740. In the seventh embodiment, the communication device 700 may include at least two independent TX chains and at least two independent RX chains.

The front-end signal processing circuit 71 may include a TX signal processing circuit 710-1, a DAC 750-1, an RX signal processing circuit 720-1, and an ADC 760-1, and may further include the antenna Ant_A configured on a TX chain S1_Tx and the antenna Ant_A configured on an RX chain S1_Rx.

The front-end signal processing circuit 72 may include a TX signal processing circuit 710-2, a DAC 750-2, an RX signal processing circuit 720-2, and an ADC 760-2, and may further include the antenna Ant_B configured on a TX chain S2_Tx and the antenna Ant_B configured on an RX chain S2_Rx.

In the seventh embodiment, the front-end signal processing circuit 71 may be a first transceiver circuit S1, and the front-end signal processing circuit 72 may be a second transceiver circuit S2. As a result, the communication device 700 may be a 2Tx2R Wi-Fi communication device. The front-end signal processing circuits 71 and 72 may form an MIMO system, and the communication device 700 may use the two transceiver circuits for performing MIMO communications.

The communication device 700 may operate in at least two different operating modes, such as a communication mode and a sensing mode. In the communication mode, the TX chain S1_Tx and the RX chain S1_Rx operate cooperatively in a half-duplex manner and the TX chain S2_Tx and the RX chain S2_Rx operate cooperatively in the half-duplex manner. In the sensing mode, the communication device 700 performs mono-static sensing, and both the TX chain S1_Tx and the RX chain S2_Rx (or both the TX chain S2_Tx and the RX chain S1_Rx) operate in a full-duplex manner. As a result, in the sensing mode, both the TX chain and the RX chain are used, and their operation or usage times may overlap.

FIG. 7 illustrates architecture where a 2Tx2R Wi-Fi communication device performs 1Tx1R mono-static sensing. It should be noted that the components filled with diagonal lines in FIG. 7 are disabled or closed in the sensing mode, but the present invention is not limited thereto.

In the sensing mode, the control unit 740 may generate bit stream data for sensing, and provide the bit stream data to the baseband signal processing circuit 730. The modulation circuit 731 may generate a modulation signal with a Wi-Fi OFDM format according to the bit stream data, wherein the modulation signal is a frequency-domain signal. The conversion circuit 732 may perform a frequency-to-time domain conversion operation upon the modulation signal in order to generate a time-domain digital signal. According to an embodiment of the present invention, the time-domain digital signal may include a predetermined packet for sensing, and the predetermined packet carries the bit stream data generated by the control unit 740.

The control unit 740 may generate a control signal Ctrl_Tx_1 in order to enable the TX signal processing circuit 710-1 and the DAC 750-1 on the TX chain S1_Tx, and generate a control signal Ctrl_Rx_1 in order to close or disable the RX signal processing circuit 720-1 and the ADC 760-1 on the RX chain S1_Rx. Similarly, the control unit 740 may generate a control signal Ctrl_Tx_2 in order to close or disable the TX signal processing circuit 710-2 and the DAC 750-2 on the TX chain S2_Tx, and generate a control signal Ctrl_Rx_2 in order to enable the RX signal processing circuit 720-2 and the ADC 760-2 on the RX chain S2_Rx.

The DAC 750-1 may convert the time-domain digital signal including the predetermined packet into a time-domain analog signal, and the TX signal processing circuit 710-1 may perform corresponding operations such as mixing (e.g., up-conversion), filtering, and amplification, and transmit the RF signal including the predetermined packet to the radio interface via the antenna Ant_A.

According to an embodiment of the present invention, the control unit 740 may control the TX power of the predetermined packet in order to meet both the Wi-Fi TX requirements and the mono-static sensing requirements. For example, the TX power of the predetermined packet is associated with the sensing distance or the sensing range, and the control unit 740 may set the TX power according to the required sensing distance or sensing range.

Regarding RX signal processing, in the sensing mode, the RX signal processing circuit 720-2 may receive an RF signal via the antenna Ant_B, wherein the RF signal includes a received packet originating from the predetermined packet. The RX signal processing circuit 720-2 may perform corresponding operations such as mixing (e.g., down-conversion), filtering, and amplification upon the received RF signal in order to generate a time-domain analog signal. The ADC 760-2 may convert the time-domain analog signal into a time-domain digital signal.

The baseband signal processing circuit 730 may receive the time-domain digital signal including the received packet. The difference between the fourth embodiment and the seventh embodiment is that, in the seventh embodiment, the same conversion circuit 732 is shared by the TX chain S1_Tx and the RX chain S2_Rx in the sensing mode. As a result, the conversion circuit 732 may be a conversion circuit capable of performing the FFT and the iFFT.

In the seventh embodiment, the baseband signal processing circuit 730 may further include a register 735. The register 735 may be arranged to temporarily store a received packet in the sensing mode. For example, when resources of the conversion circuit 732 are occupied to perform a frequency-to-time domain conversion operation upon the modulation signal, the register 735 may temporarily store the received packet provided to the baseband signal processing circuit 730 by the RX chain. After the resources of the conversion circuit 732 are released, the conversion circuit 732 may obtain the received packet from the register 735, and perform a time-to-frequency domain conversion operation upon the received packet in order to generate a frequency-domain baseband signal for channel estimating.

The channel estimation device 734 may perform a channel estimation operation according to the frequency-domain signal in order to generate channel information for providing to the control unit 740. In the sensing mode, the control unit 740 may determine an object characteristic within the wireless communication environment based on the channel information. For example, the control unit 740 may perform object presence detection, object positioning (localization), object tracking, object motion detection, object activity recognition, object vital sign monitoring, and object imaging.

The operations of components included in the communication device 700 are generally the same as those of the communication device 400 of the fourth embodiment. Therefore, detailed descriptions of the components within communication device 700 can be found in the descriptions of the corresponding components in FIG. 4. In addition, for other controls and operations of the communication device 700 in the communication mode and the sensing mode that are not described herein, reference may be made to the relevant paragraphs associated with FIG. 4, and detailed descriptions are omitted here for brevity.

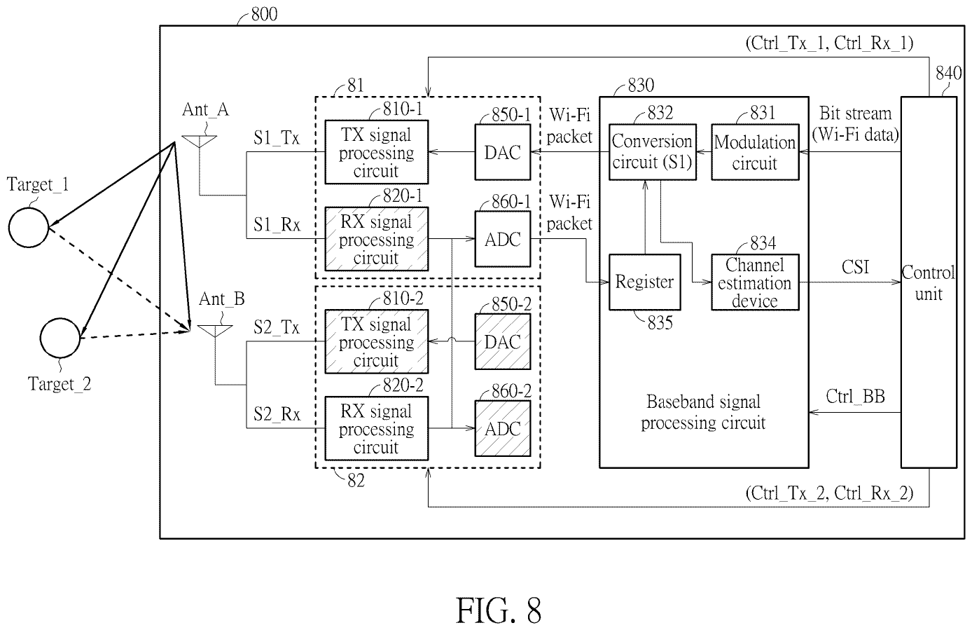

FIG. 8 is a block diagram illustrating an example of a communication device 800 according to an eighth embodiment of the present invention. The communication device 800 may include antennas Ant_A and Ant_B, front-end signal processing circuits 81 and 82, a baseband signal processing circuit 830, and a control unit 840. In the eighth embodiment, the communication device 800 may include at least two independent TX chains and at least two independent RX chains.

The front-end signal processing circuit 81 may include a TX signal processing circuit 810-1, a DAC 850-1, an RX signal processing circuit 820-1, and an ADC 860-1, and may further include the antenna Ant_A configured on a TX chain S1_Tx and the antenna Ant_A configured on an RX chain S1_Rx.

The front-end signal processing circuit 82 may include a TX signal processing circuit 810-2, a DAC 850-2, an RX signal processing circuit 820-2, and an ADC 860-2, and may further include the antenna Ant_B configured on a TX chain S2_Tx and the antenna Ant_B configured on an RX chain S2_Rx.

In the eighth embodiment, the front-end signal processing circuit 81 may be a first transceiver circuit S1, and the front-end signal processing circuit 82 may be a second transceiver circuit S2. As a result, the communication device 800 may be a 2Tx2R Wi-Fi communication device. The front-end signal processing circuits 81 and 82 may form an MIMO system, and the communication device 800 may use the two transceiver circuits for performing MIMO communications.

The communication device 800 may operate in at least two different operating modes, such as a communication mode and a sensing mode. In the communication mode, the TX chain S1_Tx and the RX chain S1_Rx operate cooperatively in a half-duplex manner and the TX chain S2_Tx and the RX chain S2_Rx operate cooperatively in the half-duplex manner. In the sensing mode, the communication device 800 performs mono-static sensing, and both the TX chain S1_Tx and the RX chain S2_Rx (or both the TX chain S2_Tx and the RX chain S1_Rx) operate in a full-duplex manner. As a result, in the sensing mode, both the TX chain and the RX chain are used, and their operation or usage times may overlap.

FIG. 8 illustrates architecture where a 2Tx2R Wi-Fi communication device performs 1Tx1R mono-static sensing. It should be noted that the components filled with diagonal lines in FIG. 8 are disabled or closed in the sensing mode, but the present invention is not limited thereto.

In the sensing mode, the control unit 840 may generate bit stream data for sensing, and provide the bit stream data to the baseband signal processing circuit 830. The modulation circuit 831 may generate a modulation signal with a Wi-Fi OFDM format according to the bit stream data, wherein the modulation signal is a frequency-domain signal. The conversion circuit 832 may perform a frequency-to-time domain conversion operation upon the modulation signal in order to generate a time-domain digital signal. According to an embodiment of the present invention, the time-domain digital signal may include a predetermined packet for sensing, and the predetermined packet carries the bit stream data generated by the control unit 840.

The control unit 840 may generate a control signal Ctrl_Tx_1 in order to enable the TX signal processing circuit 810-1 and the DAC 850-1 on the TX chain S1_Tx, and generate a control signal Ctrl_Rx_1 in order to close or disable the RX signal processing circuit 820-1 on the RX chain S1_Rx. Similarly, the control unit 840 may generate a control signal Ctrl_Tx_2 in order to close or disable the TX signal processing circuit 810-2 and the DAC 850-2 on the TX chain S2_Tx.

The difference between the seventh embodiment and the eighth embodiment is that, in the eighth embodiment, the analog-to-digital conversion operation for the received signals in the sensing mode is modified to be performed by the ADC 860-1 within the front-end signal processing circuit 81. As a result, the RX signal processing circuit 820-2 may be further coupled to the ADC 860-1 within the front-end signal processing circuit 81. The control unit 840 may generate a control signal Ctrl_Rx_2 in order to enable the RX signal processing circuit 820-2 on the RX chain S2_Rx, and disable or close the ADC 860-2 on the RX chain S2_Rx. In addition, the control unit 840 may generate the control signal Ctrl_Rx_1 in order to enable the ADC 860-1 on the RX chain S1_Rx.

The DAC 850-1 may convert the time-domain digital signal including the predetermined packet into a time-domain analog signal, and the TX signal processing circuit 810-1 may perform corresponding operations such as mixing (e.g., up-conversion), filtering, and amplification, and transmit the RF signal including the predetermined packet to the radio interface via the antenna Ant_A.

According to an embodiment of the present invention, the control unit 840 may control the TX power of the predetermined packet in order to meet both the Wi-Fi TX requirements and the mono-static sensing requirements. For example, the TX power of the predetermined packet is associated with the sensing distance or the sensing range, and the control unit 840 may set the TX power according to the required sensing distance or sensing range.

Regarding RX signal processing, in the sensing mode, the RX signal processing circuit 820-2 may receive an RF signal via the antenna Ant_B, wherein the RF signal includes a received packet originating from the predetermined packet. The RX signal processing circuit 820-2 may perform corresponding operations such as mixing (e.g., down-conversion), filtering, and amplification upon the received RF signal in order to generate a time-domain analog signal. The ADC 860-1 may convert the time-domain analog signal into a time-domain digital signal.

The baseband signal processing circuit 830 may receive the time-domain digital signal including the received packet. In the eighth embodiment, the same conversion circuit 832 is shared by the TX chain S1_Tx and the RX chain S2_Rx in the sensing mode. As a result, the conversion circuit 832 may be a conversion circuit capable of performing the FFT and the iFFT.

In the eighth embodiment, the baseband signal processing circuit 830 may further include a register 835. The register 835 may be arranged to temporarily store a received packet in the sensing mode. For example, when resources of the conversion circuit 832 are occupied to perform a frequency-to-time domain conversion operation upon the modulation signal, the register 835 may temporarily store the received packet provided to the baseband signal processing circuit 830 by the RX chain. After the resources of the conversion circuit 832 are released, the conversion circuit 832 may obtain the received packet from the register 835, and perform a time-to-frequency domain conversion operation upon the received packet in order to generate a frequency-domain baseband signal for channel estimating.

The channel estimation device 834 may perform a channel estimation operation according to the frequency-domain signal in order to generate channel information for providing to the control unit 840. In the sensing mode, the control unit 840 may determine an object characteristic within the wireless communication environment based on the channel information. For example, the control unit 840 may perform object presence detection, object positioning (localization), object tracking, object motion detection, object activity recognition, object vital sign monitoring, and object imaging.

The operations of components included in the communication device 800 are generally the same as those of the communication device 400 of the fourth embodiment. Therefore, detailed descriptions of the components within communication device 800 can be found in the descriptions of the corresponding components in FIG. 4. In addition, for other controls and operations of the communication device 800 in the communication mode and the sensing mode that are not described herein, reference may be made to the relevant paragraphs associated with FIG. 4, and detailed descriptions are omitted here for brevity.

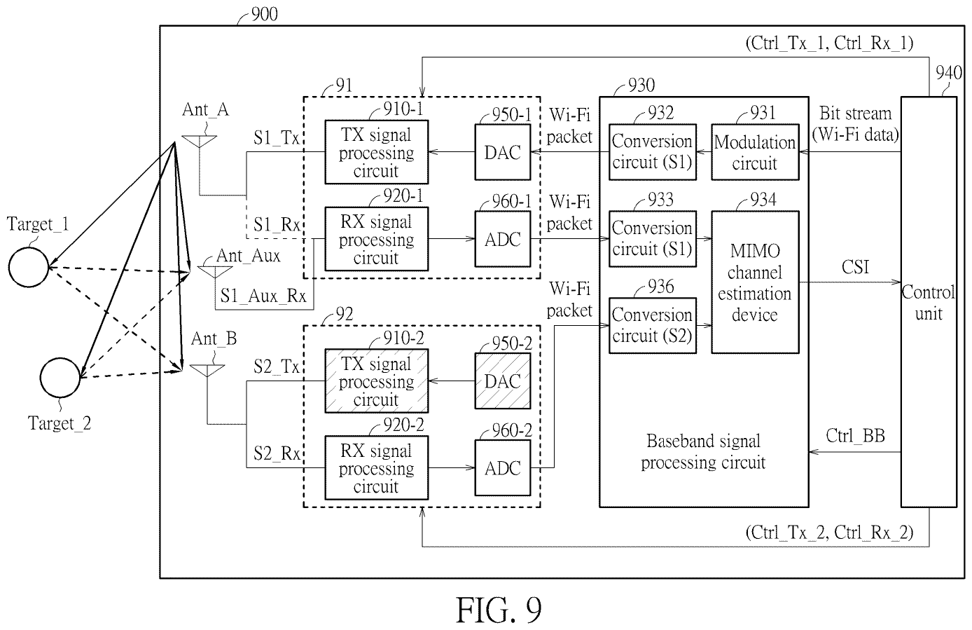

FIG. 9 is a block diagram illustrating an example of a communication device 900 according to a ninth embodiment of the present invention. The communication device 900 may include antennas Ant_A and Ant_B, front-end signal processing circuits 91 and 92, a baseband signal processing circuit 930, and a control unit 940. In the ninth embodiment, the communication device 900 may include at least two independent TX chains and at least two independent RX chains.

The front-end signal processing circuit 91 may include a TX signal processing circuit 910-1, a DAC 950-1, an RX signal processing circuit 920-1, and an ADC 960-1, and may further include the antenna Ant_A configured on a TX chain S1_Tx and the antenna Ant_A configured on an RX chain S1_Rx.

The front-end signal processing circuit 92 may include a TX signal processing circuit 910-2, a DAC 950-2, an RX signal processing circuit 920-2, and an ADC 960-2, and may further include the antenna Ant_B configured on a TX chain S2_Tx and the antenna Ant_B configured on an RX chain S2_Rx.

In the ninth embodiment, the front-end signal processing circuit 91 may be a first transceiver circuit S1, and the front-end signal processing circuit 92 may be a second transceiver circuit S2. As a result, the communication device 900 may be a 2Tx2R Wi-Fi communication device. According to an embodiment of the present invention, the baseband signal processing circuit 930 may include two baseband circuits, wherein each baseband circuit may correspond to a transceiver circuit, and may include one or more of a modulation circuit, a conversion circuit, and a channel estimation device for performing corresponding baseband signal processing. In order to simplify the illustration and facilitate the description of operations in the sensing mode, FIG. 9 only shows a portion of the baseband signal processing circuit 930. Those skilled in the art can infer the omitted portions of FIG. 9 based on the circuits and the device connections disclosed in other embodiments.

The front-end signal processing circuits 91 and 92 may form an MIMO system, and the communication device 900 may use the two transceiver circuits for performing MIMO communications. In addition, the communication device 900 may further include an independent antenna Ant_Aux configured on an RX chain S1_Aux_Rx.

The communication device 900 may operate in at least two different operating modes, such as a communication mode and a sensing mode. In the communication mode, the TX chain S1_Tx and the RX chain S1_Rx operate cooperatively in a half-duplex manner and the TX chain S2_Tx and the RX chain S2_Rx operate cooperatively in the half-duplex manner. In the sensing mode, the communication device 900 performs mono-static sensing, and the TX chain S1_Tx, the RX chain S1_Aux_Rx, and the RX chain S2_Rx operate in a full-duplex manner. As a result, in the sensing mode, both the TX chain and the RX chain are used, and their operation or usage times may overlap.

In the sensing mode, since the communication device 900 can receive RF signals via two RX chains S1_Aux_Rx and S2_Rx, 1Tx2R mono-static sensing can be achieved.

FIG. 9 illustrates architecture where a 2tx2r Wi-fi communication device performs 1Tx2R mono-static sensing. It should be noted that the components filled with diagonal lines in FIG. 9 are disabled or closed in the sensing mode, but the present invention is not limited thereto.

In the sensing mode, the control unit 940 may generate bit stream data for sensing, and provide the bit stream data to the baseband signal processing circuit 930. The modulation circuit 931 may generate a modulation signal with a Wi-Fi OFDM format according to the bit stream data, wherein the modulation signal is a frequency-domain signal. The conversion circuit 932 may perform a frequency-to-time domain conversion operation upon the modulation signal in order to generate a time-domain digital signal. According to an embodiment of the present invention, the time-domain digital signal may include a predetermined packet for sensing, and the predetermined packet carries the bit stream data generated by the control unit 940.

The control unit 940 may generate a control signal Ctrl_Tx_1 in order to enable the TX signal processing circuit 910-1 and the DAC 950-1 on the TX chain S1_Tx, and generate a control signal Ctrl_Rx_1 in order to close or disable the RX signal processing circuit 920-1 and the ADC 960-1 on the RX chain S1_Aux_Rx. Similarly, the control unit 940 may generate a control signal Ctrl_Tx_2 in order to close or disable the TX signal processing circuit 910-2 and the DAC 950-2 on the TX chain S2_Tx, and generate a control signal Ctrl_Rx_2 in order to enable the RX signal processing circuit 920-2 and the DAC 960-2 on the RX chain S2_Rx.

The DAC 950-1 may convert the time-domain digital signal including the predetermined packet into a time-domain analog signal, and the TX signal processing circuit 910-1 may perform corresponding operations such as mixing (e.g., up-conversion), filtering, and amplification, and transmit the RF signal including the predetermined packet to the radio interface via the antenna Ant_A.

According to an embodiment of the present invention, the control unit 940 may control the TX power of the predetermined packet in order to meet both the Wi-Fi TX requirements and the mono-static sensing requirements. For example, the TX power of the predetermined packet is associated with the sensing distance or the sensing range, and the control unit 940 may set the TX power according to the required sensing distance or sensing range.

Regarding RX signal processing, in the sensing mode, the RX signal processing circuit 920-2 may receive an RF signal via the antenna Ant_B, wherein the RF signal includes a received packet (e.g., a first packet) originated from the predetermined packet. The RX signal processing circuit 920-2 may perform corresponding operations such as mixing (e.g., down-conversion), filtering, and amplification upon the received RF signal in order to generate a time-domain analog signal. In addition, in the sensing mode, the RX signal processing circuit 920-1 may receive an RF signal via the antenna Ant_Aux, wherein the RF signal includes a received packet (e.g., a second packet) originating from the predetermined packet. The RX signal processing circuit 920-1 may perform corresponding operations such as mixing (e.g., down-conversion), filtering, and amplification upon the received RF signal in order to generate a time-domain analog signal. The ADC 960-1 may convert the time-domain analog signal into a time-domain digital signal.

The baseband signal processing circuit 930 may receive the time-domain digital signal including the received packet. The conversion circuit 933 may be a conversion circuit corresponding to the first transceiver circuit S1, and the conversion circuit 936 may be a conversion circuit corresponding to the second transceiver circuit S2. Each of the conversion circuits 933 and 936 may perform a time-to-frequency domain conversion operation upon the time-domain signal including the received packet in order to generate a corresponding frequency-domain baseband signal. The MIMO channel estimation device 934 may perform MIMO channel estimation according to the received frequency-domain signal from different RX chains, in order to generate channel information for providing to the control unit 940.

In the sensing mode, the control unit 940 may determine an object characteristic within the wireless communication environment based on the channel information. For example, the control unit 940 may perform object presence detection, object positioning (localization), object tracking, object motion detection, object activity recognition, object vital sign monitoring, and object imaging.

The operations of components included in the communication device 900 are generally the same as those of the communication device 400 of the fourth embodiment. Therefore, detailed descriptions of the components within communication device 900 can be found in the descriptions of the corresponding components in FIG. 4. In addition, for other controls and operations of the communication device 900 in the communication mode and the sensing mode that are not described herein, reference may be made to the relevant paragraphs associated with FIG. 4, and detailed descriptions are omitted here for brevity.

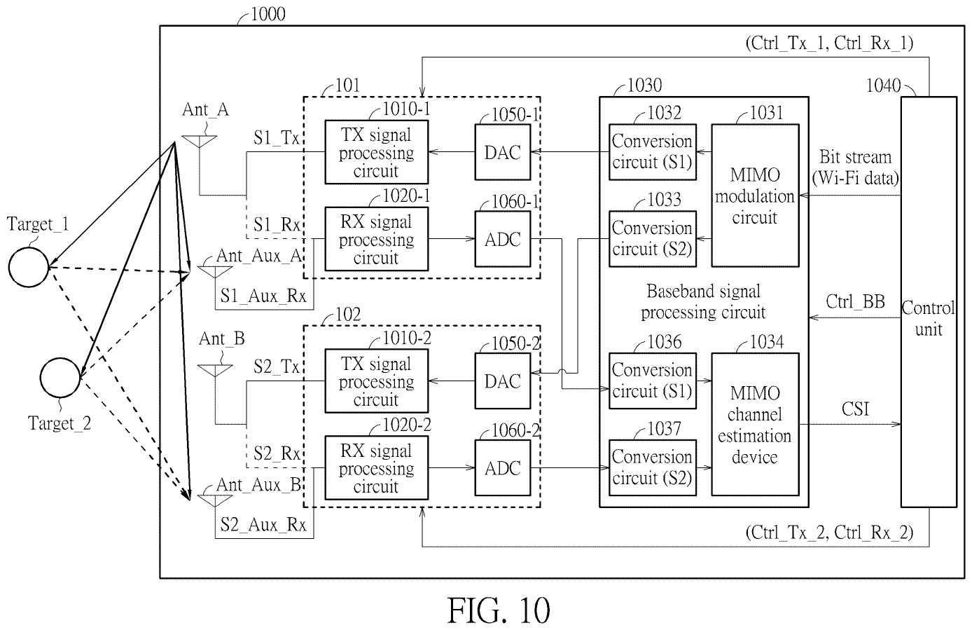

FIG. 10 is a block diagram illustrating an example of a communication device 1000 according to a tenth embodiment of the present invention. The communication device 1000 may include antennas Ant_A and Ant_B, front-end signal processing circuits 101 and 102, a baseband signal processing circuit 1030, and a control unit 1040. In the tenth embodiment, the communication device 1000 may include at least two independent TX chains and at least two independent RX chains.

The front-end signal processing circuit 101 may include a TX signal processing circuit 1010-1, a DAC 1050-1, an RX signal processing circuit 1020-1, and an ADC 1060-1, and may further include the antenna Ant_A configured on a TX chain S1_Tx and the antenna Ant_A configured on an RX chain S1_Rx.

The front-end signal processing circuit 102 may include a TX signal processing circuit 1010-2, a DAC 1050-2, an RX signal processing circuit 1020-2, and an ADC 1060-2, and may further include the antenna Ant_B configured on a TX chain S2_Tx and the antenna Ant_B configured on an RX chain S2_Rx.

In the tenth embodiment, the front-end signal processing circuit 101 may be a first transceiver circuit S1, and the front-end signal processing circuit 102 may be a second transceiver circuit S2. As a result, the communication device 1000 may be a 2Tx2R Wi-Fi communication device. According to an embodiment of the present invention, the baseband signal processing circuit 1030 may include two baseband circuits, wherein each baseband circuit may correspond to a transceiver circuit, and may include one or more of a modulation circuit, a conversion circuit, and a channel estimation device for performing corresponding baseband signal processing. In order to simplify the illustration and facilitate the description of operations in the sensing mode, FIG. 10 only shows a portion of the baseband signal processing circuit 1030. Those skilled in the art can infer the omitted portions of FIG. 10 based on the circuits and the device connections disclosed in other embodiments.

The front-end signal processing circuits 101 and 102 may form an MIMO system, and the communication device 1000 may use the two transceiver circuits for performing MIMO communications. In addition, the communication device 1000 may further include an independent antenna Ant_Aux_A configured on an RX chain S1_Aux_Rx, and an independent antenna Ant_Aux_B configured on an RX chain S2_Aux_Rx.

The communication device 1000 may operate in at least two different operating modes, such as a communication mode and a sensing mode. In the communication mode, the TX chain S1_Tx and the RX chain S1_Rx operate cooperatively in a half-duplex manner and the TX chain S2_Tx and the RX chain S2_Rx operate cooperatively in the half-duplex manner. In the sensing mode, the communication device 1000 performs mono-static sensing, and the TX chain S1_Tx, the RX chain S1_Aux_Rx, the TX chain S2_Tx, and the RX chain S2_Aux_Rx operate in a full-duplex manner. As a result, in the sensing mode, both the TX chain and the RX chain are used, and their operation or usage times may overlap.

In the sensing mode, since the communication device 1000 can transmit RF signals via two TX chains S1_Tx and S2_Tx, and can receive RF signals via two RX chains S1_Aux_Rx and S2_Aux_Rx, 2Tx2R mono-static sensing can be achieved. FIG. 10 illustrates architecture where a 2Tx2R Wi-Fi communication device performs 2Tx2R mono-static sensing.

In the sensing mode, the control unit 1040 may generate bit stream data for sensing, and provide the bit stream data to the baseband signal processing circuit 1030. The MIMO modulation circuit 1031 may generate a modulation signal with a Wi-Fi OFDM format according to the bit stream data, wherein the modulation signal is a frequency-domain signal. Each of the conversion circuits 1032 and 1033 may perform a frequency-to-time domain conversion operation upon the modulation signal in order to generate a corresponding time-domain digital signal. According to an embodiment of the present invention, the time-domain digital signal may include a predetermined packet for sensing, and the predetermined packet carries the bit stream data generated by the control unit 1040. In addition, the conversion circuit 1032 may be a conversion circuit corresponding to the first transceiver circuit S1, and the conversion circuit 1033 may be a conversion circuit corresponding to the second transceiver circuit S2.

The control unit 1040 may generate a control signal Ctrl_Tx_1 in order to enable the TX signal processing circuit 1010-1 and the DAC 1050-1 on the TX chain S1_Tx, and generate a control signal Ctrl_Rx_1 in order to enable the RX signal processing circuit 1020-1 and the ADC 1060-1 on the RX chain S1_Aux_Rx. Similarly, the control unit 1040 may generate a control signal Ctrl_Tx_2 in order to enable the TX signal processing circuit 1010-2 and the DAC 1050-2 on the TX chain S2_Tx, and generate a control signal Ctrl_Rx_2 in order to enable the RX signal processing circuit 1020-2 and the DAC 1060-2 on the RX chain S2_Aux_Rx.

The DAC 1050-1 may convert the time-domain digital signal including the predetermined packet into a time-domain analog signal, and the TX signal processing circuit 1010-1 may perform corresponding operations such as mixing (e.g., up-conversion), filtering, and amplification, and transmit the RF signal including the predetermined packet to the radio interface via the antenna Ant_A. Similarly, the DAC 1050-2 may convert the time-domain digital signal including the predetermined packet into a time-domain analog signal, and the TX signal processing circuit 1010-2 may perform corresponding operations such as mixing (e.g., up-conversion), filtering, and amplification, and transmit the RF signal including the predetermined packet to the radio interface via the antenna Ant_B.

According to an embodiment of the present invention, the control unit 1040 may control the TX power of the predetermined packet in order to meet both the Wi-Fi TX requirements and the mono-static sensing requirements. For example, the TX power of the predetermined packet is associated with the sensing distance or the sensing range, and the control unit 1040 may set the TX power according to the required sensing distance or sensing range.

Regarding RX signal processing, in the sensing mode, the RX signal processing circuit 1020-1 may receive an RF signal via the antenna Ant_Aux_A, wherein the RF signal includes a received packet (e.g., a first packet) originating from the predetermined packet. The RX signal processing circuit 1020-1 may perform corresponding operations such as mixing (e.g., down-conversion), filtering, and amplification upon the received RF signal in order to generate a time-domain analog signal. The ADC 1060-1 may convert the time-domain analog signal into a time-domain digital signal. Similarly, the RX signal processing circuit 1020-2 may receive an RF signal via the antenna Ant_Aux_B, wherein the RF signal includes a received packet (e.g., a second packet) originating from the predetermined packet. The RX signal processing circuit 1020-2 may perform corresponding operations such as mixing (e.g., down-conversion), filtering, and amplification upon the received RF signal in order to generate a time-domain analog signal. The ADC 1060-2 may convert the time-domain analog signal into a time-domain digital signal.

The baseband signal processing circuit 1030 may receive the time-domain digital signal including the received packet. The conversion circuit 1036 may be a conversion circuit corresponding to the first transceiver circuit S1, and the conversion circuit 1037 may be a conversion circuit corresponding to the second transceiver circuit S2. Each of the conversion circuits 1036 and 1037 may perform a time-to-frequency domain conversion operation upon the time-domain signal including the received packet in order to generate a corresponding frequency-domain baseband signal. The MIMO channel estimation device 1034 may perform MIMO channel estimation according to the received frequency-domain signal from different RX chains, in order to generate channel information for providing to the control unit 1040.

In the sensing mode, the control unit 1040 may determine an object characteristic within the wireless communication environment based on the channel information. For example, the control unit 1040 may perform object presence detection, object positioning (localization), object tracking, object motion detection, object activity recognition, object vital sign monitoring, and object imaging.

The operations of components included in the communication device 1000 are generally the same as those of the communication device 400 of the fourth embodiment. Therefore, detailed descriptions of the components within communication device 1000 can be found in the descriptions of the corresponding components in FIG. 4. In addition, for other controls and operations of the communication device 1000 in the communication mode and the sensing mode that are not described herein, reference may be made to the relevant paragraphs associated with FIG. 4, and detailed descriptions are omitted here for brevity.

It should be noted that, although the above embodiments describe examples of architectures for 1Tx1R mono-static sensing, 1Tx2R mono-static sensing, and 2Tx2R mono-static sensing, the present invention is not limited thereto. In other embodiments of the present invention, the 1Tx2R mono-static sensing architecture shown in FIG. 9 may be extended to an nTxmR mono-static sensing architecture based on the same concept, wherein “T” denotes transmission, “R” denotes reception, “n” and “m” are positive integers, and n<m. Similarly, the 2Tx2R mono-static sensing architecture shown in FIG. 10 may be extended to an nTxmR mono-static sensing architecture based on the same concept, wherein “T” denotes transmission, “R” denotes reception, “n” and “m” are positive integers, and n=m.

In embodiments of the present invention, various architectures for implementing mono-static sensing based on Wi-Fi chips are proposed. The communication device transmits a predetermined packet for sensing and receives an RF signal including a received packet originating from the predetermined packet, which can effectively avoid affecting the transmission and reception performance of Wi-Fi communications, and can reuse the hardware components originally designed for Wi-Fi communications to perform sensing, thereby achieving better cost efficiency.

In addition, the mono-static sensing architecture based on Wi-Fi chips proposed by the present invention can effectively address issues associated with dual-static sensing or multi-static sensing. These issues include an excessively large sensing range that can easily cause false alarms, and the fact that the transmitter and the receiver are not the same device, which prevents the receiver from obtaining RF information from the transmitter which is helpful for performing channel estimation (e.g., the initial transmission phase and the frequency offset). Furthermore, time synchronization in the dual-static sensing or the multi-static sensing is challenging, making it difficult to accurately measure the time-of-flight (ToF) of non-line-of-sight (NLoS) paths, which results in coarse object detection and recognition. Moreover, the dual-static sensing architecture or the multi-static architecture requires physically separated transmitters and receivers, which severely limits practical system deployment. Furthermore, the sensing results obtained from the dual-static sensing architecture or the multi-static architecture may lead to ambiguous interpretations of the motion of the target object.

In the mono-static sensing architecture based on Wi-Fi chips proposed by the present invention, since the sensing signal transmitter and the sensing signal receiver are the same device, the above-mentioned issues associated with dual-static sensing or multi-static sensing can be effectively resolved. Furthermore, by sharing the hardware components originally used for Wi-Fi communications to perform sensing, better cost efficiency is achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device, comprising:
a first transmitting signal processing circuit, enabled in a sensing mode, and arranged to transmit a first radio frequency (RF) signal within a wireless communication environment, wherein the first RF signal comprises a predetermined packet;
a first receiving signal processing circuit, enabled in the sensing mode, and arranged to receive a second RF signal, wherein the second RF signal comprises a first packet originating from the predetermined packet;
a baseband signal processing circuit, arranged to generate the predetermined packet according to a bit stream data, and receive the first packet from the first receiving signal processing circuit, wherein the baseband signal processing circuit is further arranged to perform a channel estimation operation according to the first packet in order to generate a channel information; and
a control unit, arranged to determine an object characteristic within the wireless communication environment according to the channel information.

2. The communication device of claim 1, wherein in the sensing mode, each of the first transmitting signal processing circuit and the first receiving signal processing circuit operates in a full-duplex manner.

3. The communication device of claim 1, wherein the control unit is further arranged to generate at least one control signal for enabling the first transmitting signal processing circuit and the first receiving signal processing circuit in the sensing mode.

4. The communication device of claim 1, further comprising:
a first antenna, coupled to the first transmitting signal processing circuit, wherein the first transmitting signal processing circuit transmits the first RF signal via the first antenna; and
a second antenna, coupled to the first receiving signal processing circuit, wherein the first receiving signal processing circuit receives the second RF signal via the second antenna.

5. The communication device of claim 4, wherein the first receiving signal processing circuit is further coupled to the first antenna; and in a communication mode, each of the first transmitting signal processing circuit and the first receiving signal processing circuit operates in a half-duplex manner.

6. The communication device of claim 1, further comprising:
a first front-end signal processing circuit, comprising the first transmitting signal processing circuit and a second receiving signal processing circuit;
a second front-end signal processing circuit, comprising a second transmitting signal processing circuit and the first receiving signal processing circuit;
a first antenna, coupled to the first front-end signal processing circuit, wherein the first transmitting signal processing circuit transmits the first RF signal via the first antenna; and
a second antenna, coupled to the second front-end signal processing circuit, wherein the first receiving signal processing circuit receives the second RF signal via the second antenna.

7. The communication device of claim 6, wherein in the sensing mode, the second receiving signal processing circuit and the second transmitting signal processing circuit are disabled, and each of the first transmitting signal processing circuit and the first receiving signal processing circuit operates in a full-duplex manner; and in a communication mode, each of the first transmitting signal processing circuit and the second receiving signal processing circuit operates in a half-duplex manner, and each of the second transmitting signal processing circuit and the first receiving signal processing circuit operates in the half-duplex manner.

8. The communication device of claim 1, wherein the baseband signal processing circuit comprises:
a modulation circuit, arranged to modulate the bit stream data in order to generate a modulation signal, wherein the modulation signal is a frequency-domain signal;
a first conversion circuit, arranged to perform a frequency-to-time domain conversion operation upon the modulation signal in order to generate the predetermined packet; and
a second conversion circuit, arrange to perform a time-to-frequency domain conversion operation upon the first packet in order to generate a frequency-domain baseband signal.

9. The communication device of claim 1, wherein the baseband signal processing circuit comprises:
a modulation circuit, arranged to modulate the bit stream data in order to generate a modulation signal, wherein the modulation signal is a frequency-domain signal;
a register, arranged to temporarily store the first packet; and
a conversion circuit, arranged to perform a frequency-to-time domain conversion operation upon the modulation signal in order to generate the predetermined packet, obtain the first packet from the register, and perform a time-to-frequency domain conversion operation upon the first packet in order to generate a frequency-domain baseband signal.

10. The communication device of claim 1, further comprising:
a second receiving signal processing circuit, enabled in the sensing mode, and arranged to receive a third RF signal, wherein the third RF signal comprises a second packet originating from the predetermined packet;
wherein the baseband signal processing circuit is further arranged to receive the second packet from the second receiving signal processing circuit, and perform the channel estimation operation according to the second packet in order to generate the channel information.
